(19) United States
(12) Patent Application Publication
(10) Pub. No.: US 2015/0270782 A1
(43) Pub. Date: Sep. 24, 2015

(54) Controlling Method for Multi-leg Isolation DC/DC Converter with Wide Input Voltage Scope

(71) Applicant: Chung-Shan Institute of Science and Technology, Longtan Township (TW)

(72) Inventors: Jonq-Chin Hwang, Taipei (TW); Po-Cheng Chen, Zhubei City (TW); Ywh-Ming Gong, Longtan (TW); Gwo-Huei You, Taipei (TW)

(73) Assignee: Chung-Shan Institute of Science and Technology, Longtan Township (TW)

(21) Appl. No.: 14/217,480

(22) Filed: Mar. 18, 2014

(51) Int. Cl. H02M 3/335

(52) U.S. Cl. CPC H02M 3/33546

(57) ABSTRACT

The present invention relates to a controlling method for multi-leg isolation DC/DC converter with wide input voltage scope, in which a transformer having at least three primary winding coils and one secondary winding coil is provided in a multi-leg DC/DC converter. Moreover, a converter controlling module is provided to treat the DC input voltage and the DC output voltage received from the multi-leg DC/DC converter with an over voltage determination, therefore the converter controlling module is able to output a proper driving signal to a plurality of power switch sets of the multi-leg DC/DC converter for making the power switch sets be operated at different ON/OFF states, so as to make the transformer has a specific coil turn ratio. By such way, the DC input voltage of the multi-leg DC/DC converter would be automatic modulated for facilitating the multi-leg DC/DC converter to provide a stable DC output voltage.

### BACKGROUND OF THE INVENTION

1. Field of the Invention

The present invention relates to the technology field of DC/DC converters, and more particularly to a controlling method for a multi-leg isolation DC/DC converter with wide input voltage scope.

2. Description of the Prior Art

With the development and advancement of industry and science technology, various electronic and electrical products are widely applied and used in human life, and it is well known that the electronic (electrical) products must be powered by electricity. However, since the power formation of the market electricity is AC power but not all electronic (electrical) products can be driven by AC power; for this reason, a variety of power converters are gradually designed and then proposed.

With reference to FIG. 1, there is shown a block diagram of a conventional regulated power supply. As shown in FIG. 1, the regulated power supply 1′ is able to output multi output voltages through the work of the voltage conversion module B and the voltage regulation module C. However, the application of the regulated power supply 1′ is still limited because having the disadvantage of low DC input voltage scope.

Referring to FIG. 2, which illustrates a circuit framework diagram of a conventional buck DC/DC converter. As shown in FIG. 2, the buck DC/DC converter 2′ is able to effectively transform the input voltage Vg′ to a target output voltage through the two power switch (S, S′) and the two power diode (CR₁, CR₂). However, it must uses many power switch driving circuits to drive the power switch (S, S′) because the buck DC/DC converter 2′ includes many power switch (S, S′), and that causes the increasing of the circuit manufacturing cost of the buck DC/DC converter 2′.

Accordingly, in view of the conventional regulated power supply and the conventional buck DC/DC converter still including drawbacks and shortcomings, the inventor of the present application has made great efforts to make inventive research thereon and eventually provided a controlling method for multi-leg isolation DC/DC converter with wide input voltage scope.

### SUMMARY OF THE INVENTION

The primary objective of the present invention is to provide a controlling method for multi-leg isolation DC/DC converter with wide input voltage scope, in which a transformer having at least three primary winding coils and one secondary winding coil is provided in a multi-leg DC/DC converter. Moreover, a converter controlling module is provided to treat the DC input voltage and the DC output voltage received from the multi-leg DC/DC converter with an over voltage determination, therefore the converter controlling module is able to output a proper driving signal to a plurality of power switch sets of the multi-leg DC/DC converter for making the power switch sets be operated at different ON/OFF states, so as to make the transformer has a specific coil turn ratio. By such way, the DC input voltage of the multi-leg DC/DC converter would be automatic modulated for facilitating the multi-leg DC/DC converter to provide a stable DC output voltage.

Accordingly, to achieve the primary objective of the present invention, the inventor of the present invention provides a controlling method for multi-leg isolation DC/DC converter with wide input voltage scope, comprising following steps:
(1) a converter controlling module receiving a DC input voltage and a DC output voltage from a multi-leg DC/DC converter;
(2) the converter controlling module determining whether the DC input voltage and the DC output voltage range between a specific input voltage scope and a specific output voltage scope, respectively; if yes, proceeding to step (3);
(3) according to the DC input voltage and the DC output voltage, the converter controlling module driving a plurality of power switch sets of the multi-leg DC/DC converter by a proper driving mode; and
(4) the power switch sets working for making a transformer of the multi-leg DC/DC converter has a specific coil turn ratio, so as to facilitate the transformer to treat the DC input voltage with a voltage transforming process by a specific voltage transformation ratio; wherein the transformer of the multi-leg DC/DC converter is winded with a first primary winding coil, a second primary winding coil, a third primary winding coil, and a secondary winding coil.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1 is a block diagram of a conventional regulated power supply;

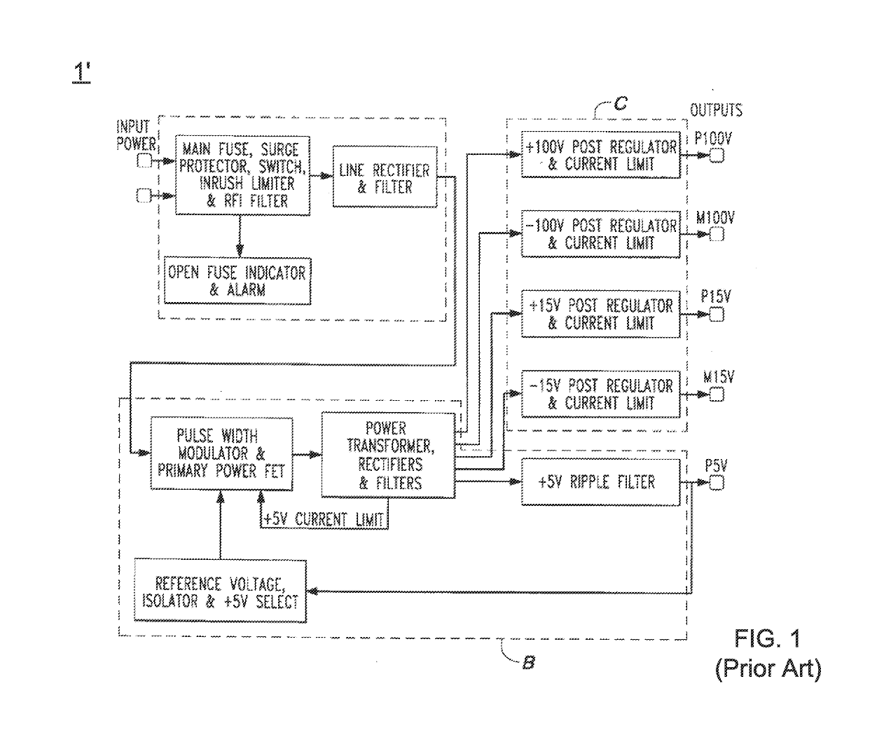

FIG. 2 is a circuit framework diagram of a conventional buck DC/DC converter;

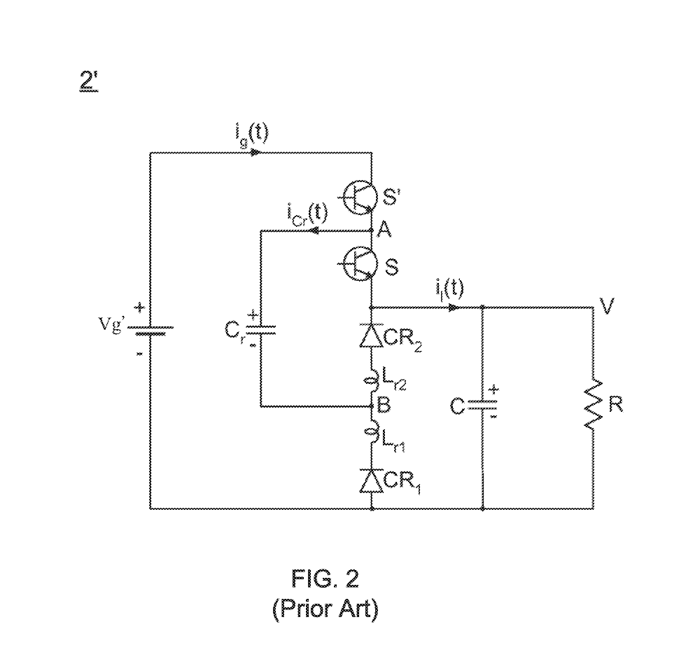

FIG. 3 is a block diagram of a multi-leg isolation DC/DC converter with wide input voltage scope according to the present invention;

FIG. 4 is a circuit framework diagram of the multi-leg isolation DC/DC converter with wide input voltage scope according to the present invention;

FIG. 5 shows a drive mode selecting table;

FIG. 6 shows an operation state table for a plurality of power switch sets of a multi-leg DC/DC converter;

FIG. 7 is a flow chart of a controlling method for multi-leg isolation DC/DC converter with wide input voltage scope according to the present invention;

FIG. 8 shows a measurement plot of the DC input voltage of the multi-leg DC/DC converter; and

FIG. 9 shows a measurement plot of the DC output voltage of the multi-leg DC/DC converter.

### DETAILED DESCRIPTION OF THE PREFERRED EMBODIMENTS

To more clearly describe a controlling method for multi-leg isolation DC/DC converter with wide input voltage scope according to the present invention, embodiments of the present invention will be described in detail with reference to the attached drawings hereinafter.

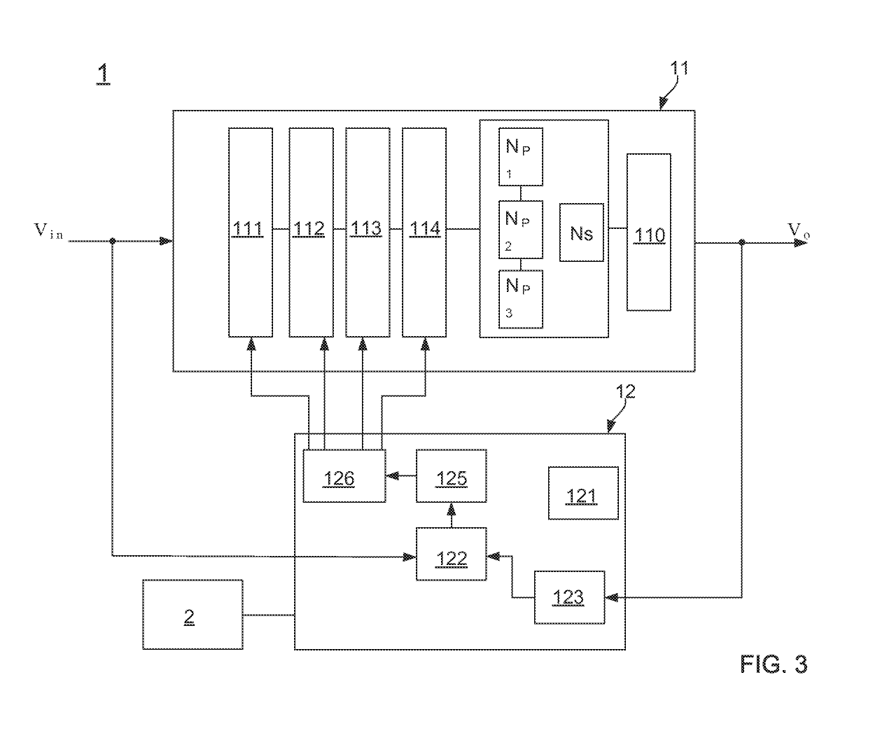

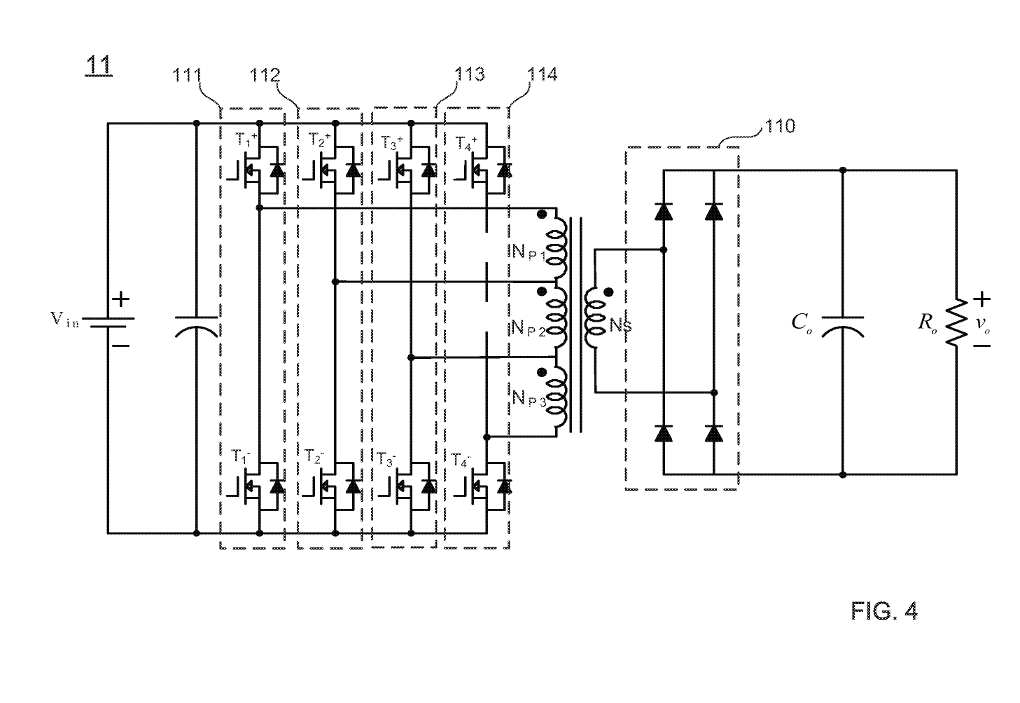

With reference to FIG. 3 and FIG. 4, there are respectively shown a block diagram and a circuit framework diagram of a multi-leg isolation DC/DC converter with wide input voltage scope according to the present invention. As shown in FIG. 3 and FIG. 4, the multi-leg isolation DC/DC converter 1 with wide input voltage scope of the present invention consists of a multi-leg DC/DC converter 11 and a converter controlling module 12 for receiving a DC input voltage Vᵢₙ and a DC output voltage V_{O} from the multi-leg DC/DC converter 11. The converter controlling module 12 is able to drive a plurality of power switch sets (111, 112, 113, 114) of the multi-leg DC/DC converter 11 by a selectively proper driving mode according to the DC input voltage Vᵢₙ and the DC output voltage V_{O}, so as to make a transformer of the multi-leg DC/DC converter 11 has a specific coil turn ratio by the working of the power switch sets (111, 112, 113, 114), and then facilitate the transformer to treat the DC input voltage Vᵢₙ with a voltage transforming process by a specific voltage transformation ratio.

As shown in FIG. 3 and FIG. 4, the transformer of the multi-leg DC/DC converter 11 is winded with a first primary winding coil N_{P1}, a second primary winding coil N_{P2}, a third primary winding coil N_{P3}, and a secondary winding coil N_{S}.

In the transformer of the multi-leg DC/DC converter 11, the coil turn ratio between the first primary winding coil N_{P1} and the secondary winding coil N_{S} is n. The coil turn ratio between the second primary winding coil N_{P2} and the secondary winding coil N_{S} is 2n. The coil turn ratio between the third primary winding coil N_{P3} and the secondary winding coil N_{S} is 3n. The coil turn ratio between the first primary winding coil N_{P1} as well as the third primary winding coil N_{P3} and the secondary winding coil N_{S} is 4n. The coil turn ratio between the second primary winding coil N_{P2} as well as the third primary winding coil N_{P3} and the secondary winding coil N_{S} is 5n. The coil turn ratio between the first primary winding coil N_{P1}, the second primary winding coil N_{P2} as well as the third primary winding coil N_{P3} and the secondary winding coil N_{S} is 6n.

Moreover, the multi-leg DC/DC converter 11 is disposed with a full-wave rectifier unit 110, an output capacitor C_{O} and an output resistor R_{O} at the output end thereof, wherein the full-wave Rectifier unit 110 is coupled to the secondary winding coil N_{S}, and the output capacitor C_{O} is parallel to the output resistor R_{O} and coupled to the full-wave Rectifier unit 110. Besides, the converter controlling module 12 is consisted of a counter 121, a feedback unit 123, an over voltage determining unit 122, a modulation unit 125, and a power switch driving module 126, wherein the feedback unit 123 is used for receiving the DC input voltage Vᵢₙ. The over voltage determining unit 122 is coupled to the feedback unit 123 and the input end of the multi-leg DC/DC converter 11 for receiving the DC input voltage Vᵢₙ and the DC output voltage V_{O}, so as to respectively determine whether the DC input voltage Vᵢₙ and the DC output voltage V_{O} range between a user-set specific input voltage scope and a user-set specific output voltage scope. The modulation unit 125 is coupled to the over voltage determining unit 122 and has a drive mode selecting function. In the present invention, the modulation unit 125 is able to select the proper driving mode to drive the power switch sets (111, 112, 113, 114) according to an over voltage determination signal outputted by the over voltage determining unit 122. The power switch driving module 126 is coupled to the modulation unit 125 and the power switch sets (111, 112, 113, 114), used for driving the power switch sets (111, 112, 113, 114) according to the proper driving mode.

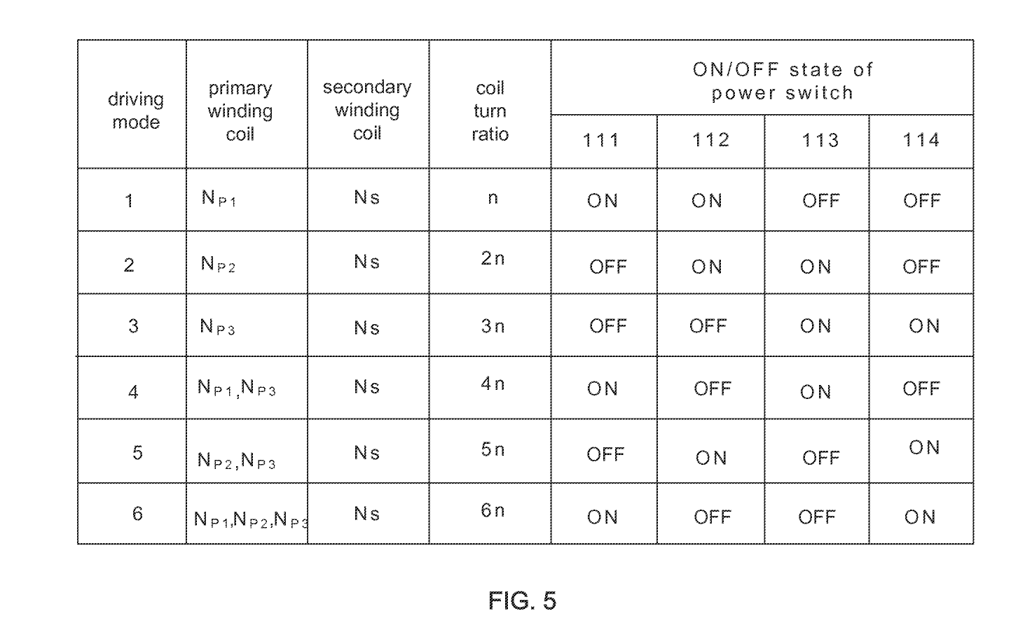

Continuously referring to FIG. 3 and FIG. 4, and please simultaneously refer to FIG. 5, which shows a drive mode selecting table. As shown in FIGs., the modulation unit 125 selects the proper driving mode for the power switch sets (111, 112, 113, 114) from the drive mode selecting table according to the over voltage condition of the DC input voltage Vᵢₙ and the DC output voltage V_{O}. When the modulation unit 125 selects driving mode 1, the ON/OFF states of the power switch sets (111, 112, 113, 114) driven by the power switch driving module 126 are (ON, ON, OFF, OFF), respectively. Therefore, the transformer of the multi-leg DC/DC converter 11 would has a specific coil turn ratio of n. Besides, When the modulation unit 125 selects driving mode 2, the ON/OFF states of the power switch sets (111, 112, 113, 114) driven by the power switch driving module 126 are respectively (OFF, ON, ON, OFF), and the specific coil turn ratio of the transformer of the multi-leg DC/DC converter 11 becomes to 2n. Moreover, When the modulation unit 125 selects driving mode 3, the ON/OFF states of the power switch sets (111, 112, 113, 114) driven by the power switch driving module 126 are respectively (OFF, OFF, ON, ON), and the specific coil turn ratio of the transformer of the multi-leg DC/DC converter 11 becomes to 3n.

Inheriting to above descriptions, when the modulation unit 125 alternatively selects driving mode 4, the ON/OFF states of the power switch sets (111, 112, 113, 114) driven by the power switch driving module 126 are (ON, OFF, ON, OFF), respectively; therefore, the transformer of the multi-leg DC/DC converter 11 would has a specific coil turn ratio of 4n. Besides, When the modulation unit 125 selects driving mode 5, the ON/OFF states of the power switch sets (111, 112, 113, 114) driven by the power switch driving module 126 are respectively (OFF, ON, OFF, ON), and the specific coil turn ratio of the transformer of the multi-leg DC/DC converter 11 becomes to 5n. Moreover, When the modulation unit 125 selects driving mode 3, the ON/OFF states of the power switch sets (111, 112, 113, 114) driven by the power switch driving module 126 are respectively (ON, OFF, OFF, ON), and the specific coil turn ratio of the transformer of the multi-leg DC/DC converter 11 becomes to 6n.

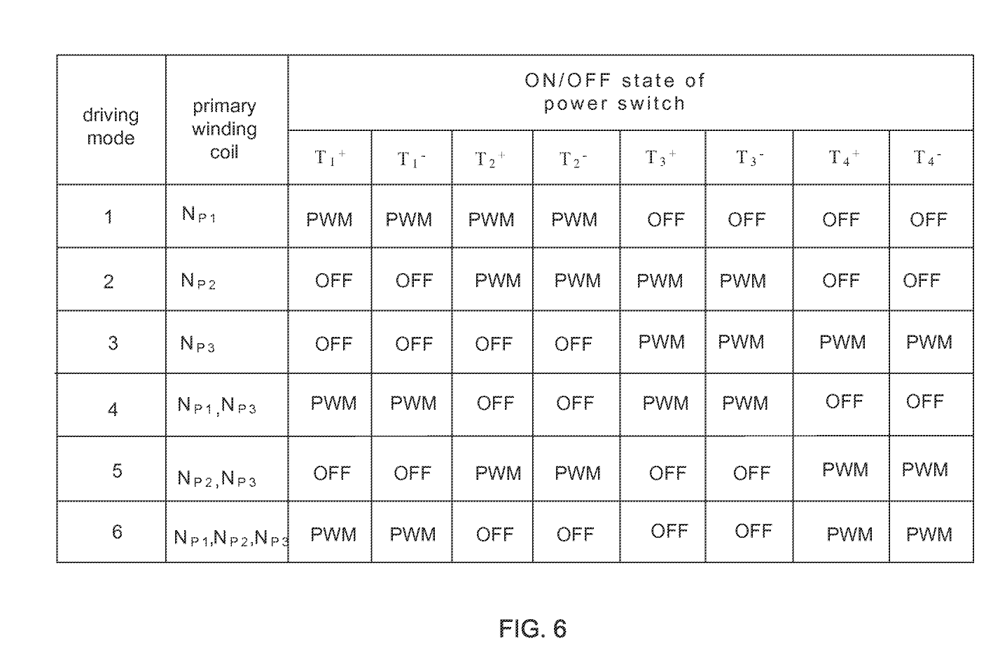

Furthermore, as the operation state table of the power switch sets (111, 112, 113, 114) shown in FIG. 6, it is able to know that each of the power switch transistors in the power switch sets (111, 112, 113, 114) are driven by PWM driving signal. Moreover, from FIG. 4 and FIG. 6, it can also know that the power switch transistors are denoted to T₁⁺, T₁⁻, T₂⁺, T₂⁻, T₃⁺, T₃⁻, T₄⁺, and T₄⁻, respectively.

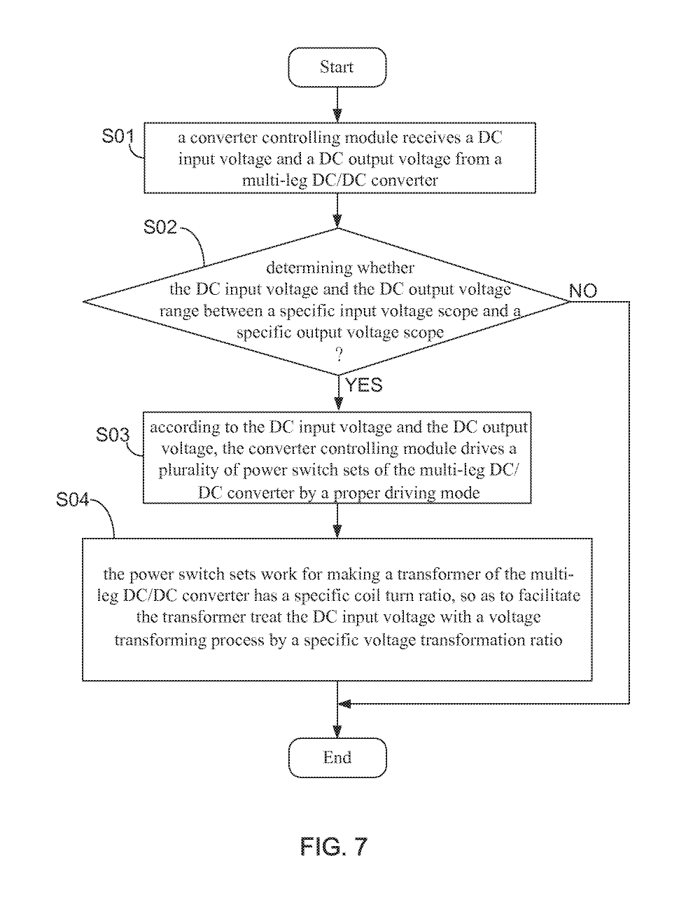

Thus, above descriptions have been completely and clearly introduced the multi-leg isolation DC/DC converter 1 with wide input voltage scope of the present invention. Next, a controlling method for the multi-leg isolation DC/DC converter 1 will be introduced in follows. Please refer to FIG. 7, there is shown a flow chart of a controlling method for the multi-leg isolation DC/DC converter with wide input voltage scope according to the present invention. As shown in FIG. 7 and FIG. FIG. 3, the controlling method of the present invention firstly executes step (S01) for facilitating the converter controlling module 12 to receive a DC input voltage Vᵢₙ and a DC output voltage V_{O} from the multi-leg DC/DC converter 11. Then, the converter controlling module 12 would determine whether the DC input voltage Vᵢₙ and the DC output voltage V_{O} range between a user-set specific input voltage scope and a user-set specific output voltage scope, respectively (step (S02)). Therefore, according to the DC input voltage Vᵢₙ and the DC output voltage V_{O}, the converter controlling module 12 drives a plurality of power switch sets (111, 112, 113, 114) of the multi-leg DC/DC converter 11 by a selected proper driving mode. Eventually, the power switch sets (111, 112, 113, 114) would be driven to work for making a transformer of the multi-leg DC/DC converter 11 has a specific coil turn ratio, so as to facilitate the transformer to treat the DC input voltage Vᵢₙ with a voltage transforming process by a specific voltage transformation ratio (step (S04)).

However, before the step (S01) is executed, it must execute steps (SP1) and (SP2) in advance; such that the user is able to set the specific input voltage scope and the specific output voltage scope by using an external host 2 connected to the converter controlling module 12, and set a counter 121 of the converter controlling module 12 through the external host, so as to make the counter 121 count a converter-modulating period when the steps (1)˜(4) are executed. Therefore, the steps (1)˜(4) would be completed during the converter-modulating period. Besides, the plurality of power switch sets (111, 112, 113, 114) of the multi-leg DC/DC converter 11 are turned off when the steps (1)˜(3) are executed.

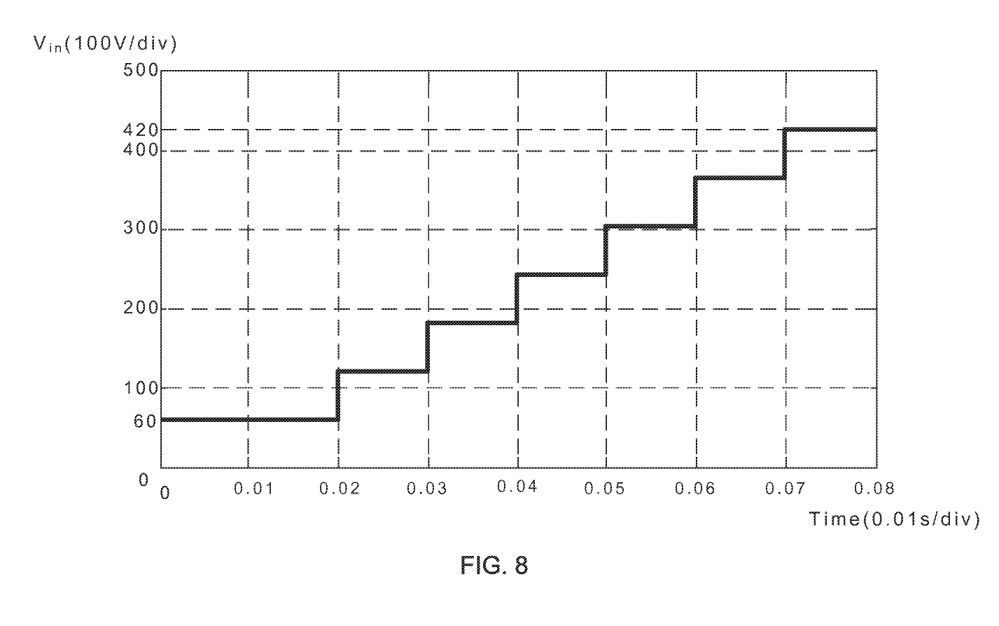

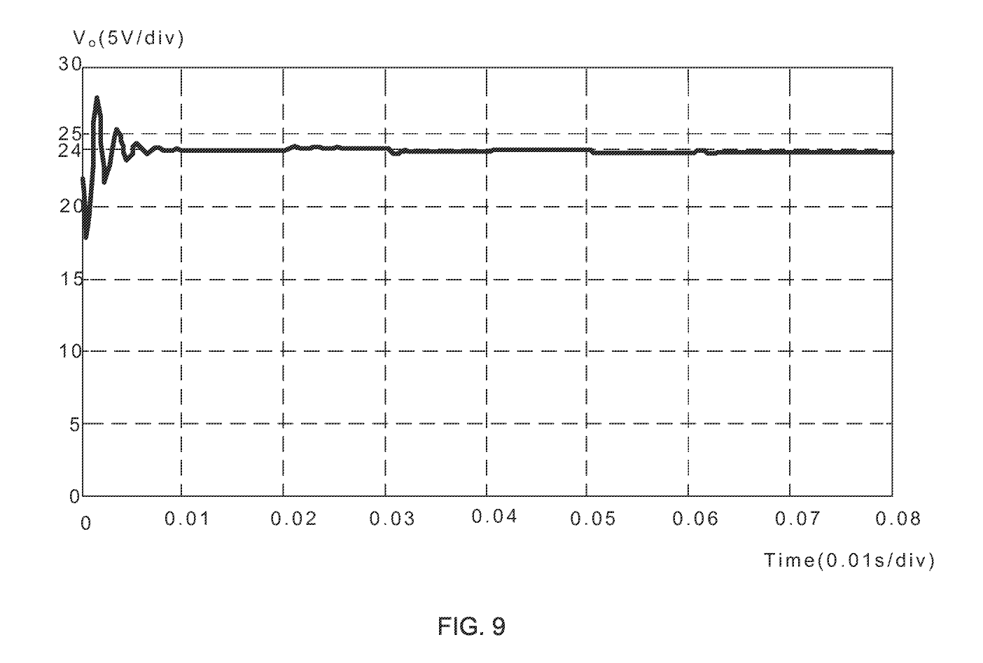

Please refer to FIG. 8 and FIG. 9, there are shown two measurement plots of the DC input voltage of the multi-leg DC/DC converter. As shown in FIG. 8, the converter controlling module 12 treats the DC input voltage Vᵢₙ with a voltage modulating process in the converter-modulating period of 0.01 s, so as to gradually adjust the DC input voltage Vᵢₙ from 60V to 420V. Moreover, from FIG. 9, it is able to find that the DC output voltage Vₒᵤₜ provided by the multi-leg isolation DC/DC converter 1 is maintained at 24V even if the DC input voltage Vᵢₙ is adjusted from 60V to 420V.

The above description is made on embodiments of the present invention. However, the embodiments are not intended to limit scope of the present invention, and all equivalent implementations or alterations within the spirit of the present invention still fall within the scope of the present invention.

What is claimed is:

1. A controlling method for multi-leg isolation DC/DC converter with wide input voltage scope, comprising following steps:
(1) a converter controlling module receiving a DC input voltage and a DC output voltage from a multi-leg DC/DC converter;
(2) the converter controlling module determining whether the DC input voltage and the DC output voltage range between a specific input voltage scope and a specific output voltage scope, respectively; if yes, proceeding to step (3);
(3) according to the DC input voltage and the DC output voltage, the converter controlling module driving a plurality of power switch sets of the multi-leg DC/DC converter by a proper driving mode; and
(4) the power switch sets working for making a transformer of the multi-leg DC/DC converter has a specific coil turn ratio, so as to facilitate the transformer to treat the DC input voltage with a voltage transforming process by a specific voltage transformation ratio; wherein the transformer of the multi-leg DC/DC converter is winded with a first primary winding coil, a second primary winding coil, a third primary winding coil, and a secondary winding coil.

2. The controlling method for multi-leg isolation DC/DC converter with wide input voltage scope of claim 1, further comprising following steps before executing the step (1):
setting the specific input voltage scope and the specific output voltage scope by using an external host connected to the converter controlling module; and
setting a counter of the converter controlling module through the external host, so as to make the counter count a converter-modulating period when the steps (1)˜(4) are executed.

3. The controlling method for multi-leg isolation DC/DC converter with wide input voltage scope of claim 1, wherein the multi-leg DC/DC converter is disposed with a full-wave Rectifier unit, an output capacitor and an output resistor at the output end thereof, in which the full-wave Rectifier unit is coupled to the secondary winding coil, and the output capacitor being parallel to the output resistor and coupled to the full-wave Rectifier unit.

4. The controlling method for multi-leg isolation DC/DC converter with wide input voltage scope of claim 1, wherein the coil turn ratio between the first primary winding coil and the secondary winding coil is n; the coil turn ratio between the second primary winding coil and the secondary winding coil is 2n; the coil turn ratio between the third primary winding coil and the secondary winding coil is 3n; the coil turn ratio between the first primary winding coil as well as the third primary winding coil and the secondary winding coil is 4n; the coil turn ratio between the second primary winding coil as well as the third primary winding coil and the secondary winding coil is 5n; the coil turn ratio between the first primary winding coil, the second primary winding coil as well as the third primary winding coil and the secondary winding coil is 6n.

5. The controlling method for multi-leg isolation DC/DC converter with wide input voltage scope of claim 2, wherein the steps (1)˜(4) are completed during the converter-modulating period.

6. The controlling method for multi-leg isolation DC/DC converter with wide input voltage scope of claim 2, wherein the plurality of power switch sets of the multi-leg DC/DC converter are turned off when the steps (1)˜(3) are executed.

7. The controlling method for multi-leg isolation DC/DC converter with wide input voltage scope of claim 2, wherein the converter controlling module further comprises:
a feedback unit, being used for receiving the DC output voltage;
an over voltage determining unit, being coupled to the feedback unit and the input end of the multi-leg DC/DC converter for receiving the DC input voltage and the DC output voltage, so as to respectively determine whether the DC input voltage and the DC output voltage range between the specific input voltage scope and the specific output voltage scope;
a modulation unit, being coupled to the over voltage determining unit and having a drive mode selecting function, wherein the modulation unit is able to select the proper driving mode to drive the power switch sets according to an over voltage determination signal outputted by the over voltage determining unit; and
a power switch driving module, being coupled to the modulation unit and the power switch sets, and used for driving the power switch sets according to the proper driving mode.
